(19) United States
(12) Patent Application Publication
(10) Pub. No.: US 2003/0030751 A1
(43) Pub. Date: Feb. 13, 2003

(54) System and method for wireless access to pay fer view program guide

(76) Inventors: Ruben D. Lupulescu, Lauderdale, FL (US); Chris Stewart, Tamarac, FL (US)

Correspondence Address: HUGHES ELECTRONICS CORPORATION, PATENT DOCKET ADMINISTRATION, BLDG 001 M/S A109, P O BOX 956, EL SEGUNDO, CA, 902450956

(21) Appl. No.: 10/051,955

(22) Filed: Jan. 17, 2002

Related U.S. Application Data
(60) Provisional application No. 60/312,167, filed on Aug. 13, 2001.

(51) Int. Cl. H04N 7/16; G06F 3/00; H04N 5/445; G06F 13/00; H04N 7/173; H04N 7/00; H04N 11/00

(52) U.S. Cl. 348/552; 725/39; 725/50; 725/1; 725/61; 725/60; 725/104; 725/133; 725/25

(57) ABSTRACT

A system and method for purchasing Pay Per View (“PPV”) television events by using a wireless communications device such as a cellular phone having Wireless Application Protocol Technology. The system and method of the present invention allows a subscriber, when away from home, to purchase PPV events for the subscriber's television system by using a WAP-enabled cellular phone or PDA and accessing a database on a server wherein the database is also WAP-enabled. The present invention uses a wireless Internet connection to facilitate a wireless purchase of a PPV event thus resulting in immediate processing, billing and accounting. The subscriber can view PPV event schedules and purchase PPV events by selecting the desired event directly from the display screen on the subscriber's cellular telephone. A reminder message can be sent to the subscriber's cellular telephone minutes before the start of the event.

### BACKGROUND OF THE INVENTION

1. Field of the Invention

This invention relates generally to a system and method for accessing television Pay Per View program guide event schedules and pricing information and for purchasing Pay Per View television events by using a wireless device such as a cellular phone with Wireless Application Protocol Technology.

2. Description of the Prior Art

Typically, when ordering Pay-Per-View (“PPV”) satellite television events, a potential viewer is positioned in front of the viewer's television, remote in hand, while following the onscreen ordering directions. Another way of ordering PPV events is via the viewer s PC, over the Internet. Finally, the viewer can telephone the viewer's television company and speak to a customer representative who can provide assistance to the viewer in ordering PPV events.

However, there are significant drawbacks in each of these methods. Systems used for ordering PPV events, accessing a PPV account, or accessing a PPV event schedule via the television, such as IPPV (Impulse Pay Per View), require the viewer's receiver to be continuously connected to a land-based telephone line, otherwise the viewer cannot the remote control to access PPV information. Although some systems allow the viewer to order there is usually a limit to the number of PPV programs the viewer can order. After this limit is reached, if the viewer wants to make any further PPV orders, there must be a dedicated telephone line connected to the viewer's receiver. In many homes, particularly in Latin America countries, it is too costly or not practical to have an additional telephone line connected to the television receiver.

While many television providers have a website that viewers can access to obtain PPV event scheduling and ordering information, not every household has a PC.

Finally, calling a customer service representative, while having the advantage of dealing with a live person, often takes too much time, sometimes as much as thirty minutes, is frustrating and given today's fast-paced world, is totally impractical for such a simple task as viewing a listing of movies, viewing one's account and/or ordering a PPV event or movie.

The present invention bypasses the need for a dedicated telephone land line to be attached to the viewer's receiver, and does not require a callback every month to the receiver. This means that the system is a potential solution for a customer that does not have landline connections, such as in Latin America, as well as customers that use satellite systems on a mobile installation such as a boat or a recreational vehicle (RV).

Accordingly, what is needed in the art is a system and method designed to allow a satellite television subscriber to access his or her account, obtain a listing of PPV events, promotions and movies and order the event of choice, all from a wireless device, such as a cell phone and without the necessity of having a PC or permanent land-line telephone connection to the subscriber's satellite television receiver.

It is, therefore, to the effective resolution of the aforementioned problems and shortcomings of the prior art that the present invention is directed.

### SUMMARY OF THE INVENTION

A mobile Pay-Per-View (“m-PPV”) system and method allowing a subscriber to purchase Pay Per View (“PPV”) events for the subscriber's television system, by using a wireless device such as a cell phone and by using Wireless Application Protocol (WAP) Technology. The present invention m-PPV system uses a wireless Internet connection to facilitate a wireless purchase of a Pay Per View event thus resulting in immediate Pay Per View processing as well as billing and accounting. The ability to order Pay Per View events using the present invention opens a new avenue for ordering Pay Per View programs, which was not available before.

The m-PPV system of the present invention is a revenue generating service that gives customers flexibility and ordering power in their hands, while also reducing customer service calls for Phone Pay Per View offers. The m-PPV system is adaptable to for any cable or satellite television system, thus giving the freedom and flexibility to browse and order pay per view programs and events from a wireless device such as a cellular telephone.

The present invention provides television program purchasing functionality to satellite television subscribers who do not have the ability to purchase television PPV programs with the remote control because of the unavailability of the service through the subscriber's Integrated Receiver Decoder (IRD).

The invention is a system and method of displaying television event guide information on a user's wireless data communication device to allow the user to purchase television programs and access user purchasing records.

The first steps of the method allows the user to access, with a wireless communication device, a database stored on a server in a data communication network, the database containing television event schedules and user records of previous user purchases. The television events are preferably Pay-Per-View (PPV) movies and PPV promotional events. The second steps provide a display on the user's wireless communication device with selection options including an option to purchase the television events and an option to view the user's television event purchasing records. Once the user selects the option to purchase the television programs, the user's display on the user's wireless communication device shows a text list of available television events. In response to the user's selection of the option to view the user's television event purchasing records, the display on the user's wireless communication device provides a list of previous television event purchases by the user. Finally, the user is allowed to purchase the available television events.

Preferably, the user's wireless communication device is a cellular telephone that is WAP enabled and the television event guide information is stored on a website that is WAP formatted. Other WAP-enabled wireless communication devices such as PDAs, are also within the scope of this invention.

In the preferred embodiment, in order to gain access to the database, the user must provide a user access code, which is compared with a database of existing subscriber access codes.

In one embodiment, prior to the step of displaying on the user's wireless communication device a listing of available said television events, the user must request the television event schedule listings for a specific television channel.

If the user has multiple accounts, prior to purchasing a television event or program, the user can identify the account, which is to be charged for the ensuing purchase.

The invention also encompasses an alternate embodiment wherein the user automatically receives notification from the system, via an e-mail sent to the user's wireless communication device, which lets the user know that the program he or she ordered is about to air. The server contains a database of users along with their PPV event purchase requests and automatically generates a call back to the user's e-mail address. This e-mail address is stored with the user's name the first time the customer utilizes the PPV ordering system of the present invention.

It is to be understood that both the foregoing general description and the following detailed description are explanatory and are not restrictive of the invention as claimed. The accompanying drawings, which are incorporated in and constitute part of the specification, illustrate the preferred embodiment of the present invention and together with the general description, serve to explain principles of the present invention.

### BRIEF DESCRIPTION OF THE DRAWINGS

FIG. 1 is a block diagram illustrating the basic WAP architecture incorporating the present invention.

FIG. 2 illustrates a flow diagram of the steps taken by the present invention.

FIG. 3 illustrates a front elevational view of a typical user's cellular telephone in conjunction with the present invention with text depicted on the Welcome Screen.

FIG. 4 illustrates a front elevational view of a user's cellular telephone in conjunction with the present invention displaying the Menu Screen.

FIG. 5 illustrates a front elevational view of a user's cellular telephone in conjunction with the present invention displaying the Television Schedule/Guide Screen.

FIG. 6 illustrates a front elevational view of a user's cellular telephone in conjunction with the present invention displaying the Pay-Per-View Events Screen.

### DESCRIPTION OF THE PREFERRED EMBODIMENT

The present invention 10 is a mobile wireless Pay Per View event and program system and method (m-PPV) that allows a television subscriber to purchase Pay Per View (PPV) events for the subscriber's television system, by using a wireless device such as a cell phone or a PDA and by using Wireless Application Protocol Technology.

The m-PPV is based on the Wireless Application Protocol (WAP) technology. WAP-compatible operating systems that are compatible with the m-PPV system are PalmOS, EPOC, Windows CE, OS/9, and JavaOS.

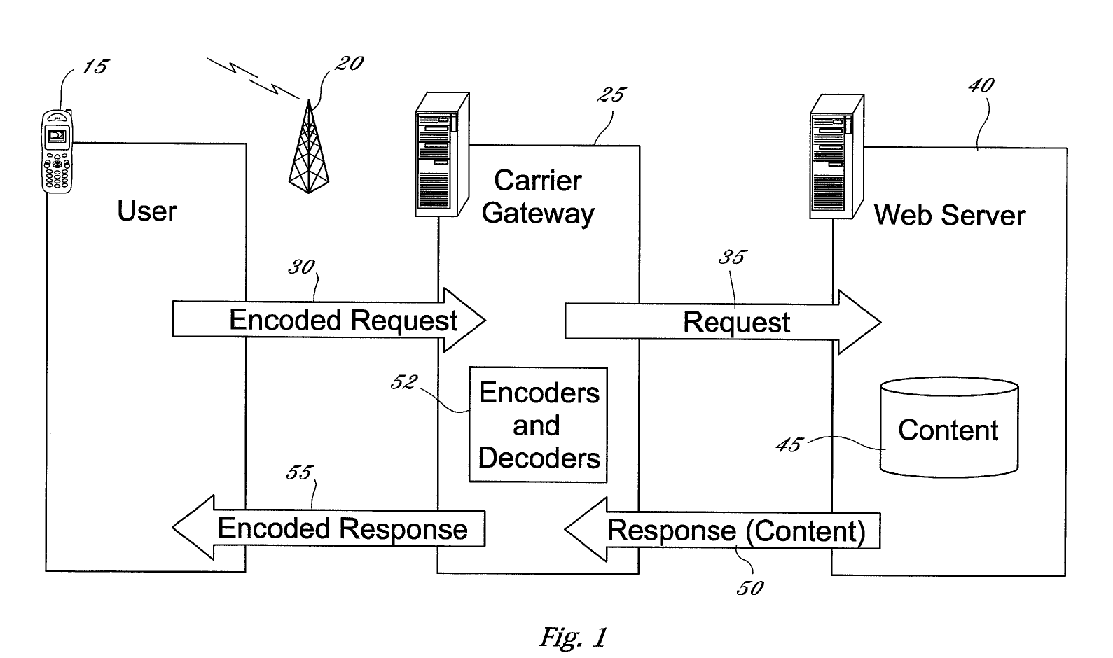

FIG. 1 is a block diagram illustrating the basic architecture of a WAP system. In the preferred embodiment, the user's wireless communications device 15 is a cellular telephone. Alternately, the user's communication device could be a PDA. The present invention will function on any WAP enabled WML compatible device.

A user with a cellular phone 15 can access the m-PPV system by typing the URL (location) of the m-PPV system and sending an encoded request 30 on cellular phone 15. The cellular phone will contact the cellular tower 20 and then a Carrier Gateway 25. The carrier Gateway 25 converts the encoded wireless request 30 from WML to HTML via encoders and encoders 52 and forwards a wireless request 35 to a Web Server 40 where the m-PPV system resides 45.

The m-PPV system is programmed in the Wireless Markup Language version 1.1 (WML 1.1). The m-PPV system resides in a regular web server such as a Windows 2000 server with IIS5, in the geographical area where the Pay Per View requests are to be processed. The m-PPV system acts like a normal web page on server 40, except for the fact that it can only be accessed and executed by a WML compatible device.

The m-PPV system, after processing the user's request 35, transmits a return response 50 where Carrier Gateway 25 again converts the response 50 to WML format. The encoded response 55 than appears on the user's cellular phone or PDA 15.

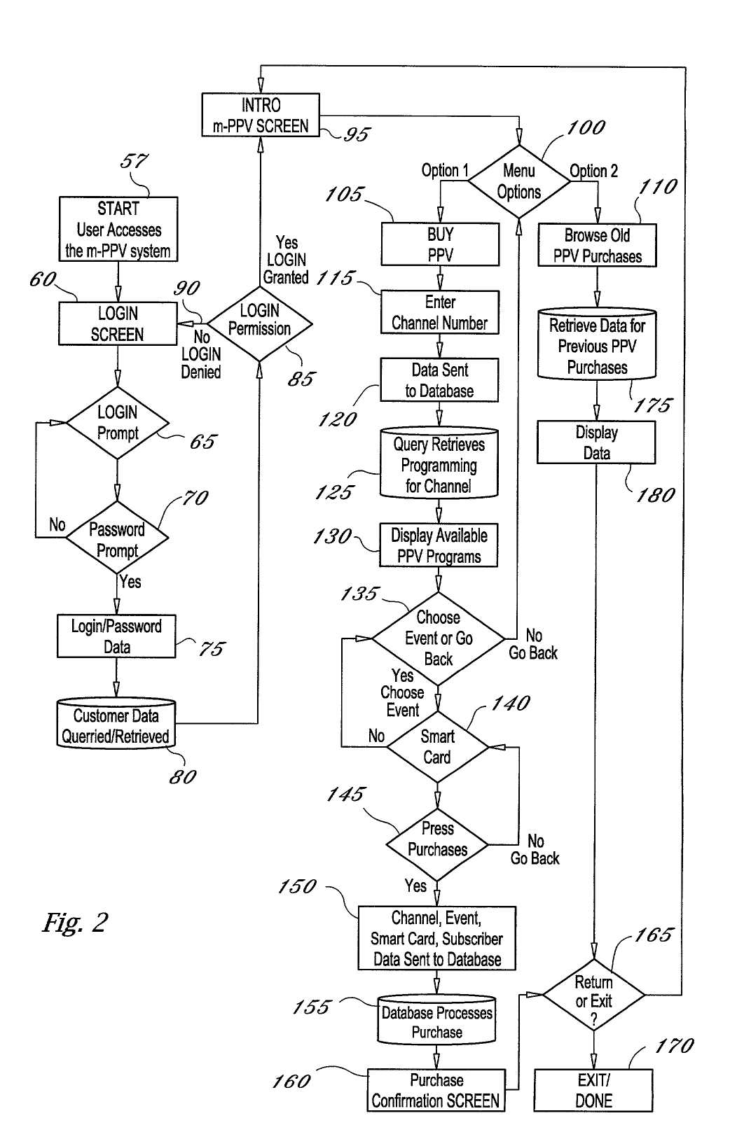

FIG. 2 illustrates the process of the present invention whereby a user with access to a wireless communications device can Receive television event guide information in order purchase television programs and access user purchasing records.

The user first accesses the m-PPV system by entering the website URL containing the PPV information database on his or her cellular phone or PDA display screen, via step 57. The database contains television event schedules and user records of previous user purchases.

After being presented with a Login screen 60, and a Login prompt 65, the system may require the user to log in with a customer ID and a password, by prompting the user to enter a password, step 70. User login and password data 75 is forwarded to the customer database. The database is queried and the user login and password data is verified 80. If the user's login data matches preexisting data in the database, login permission is granted via step 85. If no match is found, login is denied, step 90.

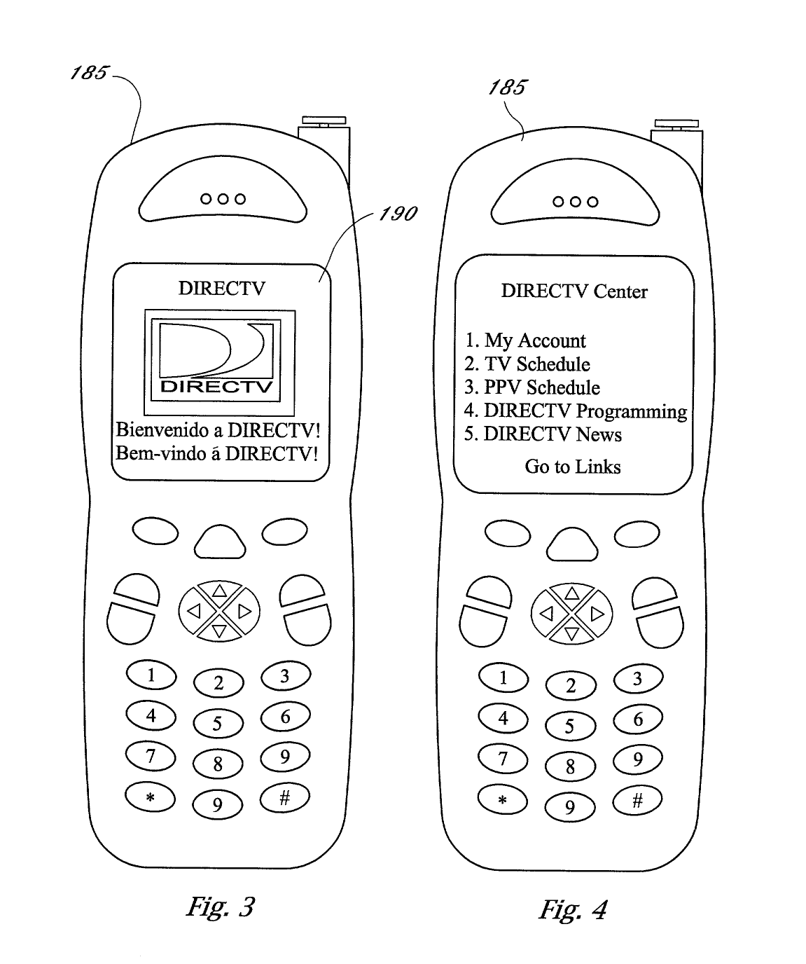

After gaining access to the system, the user is presented with a welcome screen 95, as seen in greater detail in FIG. 3 and a menu of options 100.

The user is then presented with two options: the user can purchase PPV events 105, or browse through past PPV purchases 110. Prior to purchasing a PPV event, the user may be presented with additional options, such as checking their account, accessing the TV schedule for all channels, accessing the PPV event schedule, and accessing other programming information and local, national or international news links.

The user may wish to review the PPV event schedule for a particular channel. If this is desired, the customer is prompted to enter a channel number, step 115. Upon entering a channel number, the channel request is sent to the database, via step 120, and the m-PPV system retrieves data for that channel from the Channel List file in the Database Server, via step 125. The available PPV events for the selected channels are displayed on the user's wireless communication device, step 130.

The user is then presented with the option of purchasing an event or selecting a different option, via step 135. The customer chooses the Pay Per View event of their choice and clicks the (Buy) Link button, step 145. This will retrieve a list of available Smart Cards 140 for that customer in the event that a customer owns multiple systems at multiple locations. Upon choosing the Smart Card number of choice, the m-PPV system sends a request containing channel, event, Smart Card and user identification information to the Conditional Access Management Center (CAMC) to activate the PPV request, a request to the Integrated Management Center (CAMC) to activate the PPV request, and a request to the Integrated Business System (IBS) to process the billing and accounting of the purchase, via step 150.

After processing the purchase information, step 155, the user receives conformation of his or her purchase by a confirmation message appearing on the user's wireless communication device display screen, step 160. The user can then either exit the system 170 or return to the welcome screen 95 to choose another option, via step 165.

If the user wishes to browse old PPV event purchases, an appropriate selection is made 110 and the request is sent to the database where the user's PPV purchase history is retrieved 175 and displayed 180 on the user's wireless device. Once again, the user is given the option, via step 165 of returning to the welcome screen 95 or exiting the system 170.

The following is the normal execution of steps taken by a user of the m-PPV system of the present invention:

1. User directs his or her cellular phone to the proper URL for the m-PPV system.

2. The m-PPV system prompts the user for a login and then a password for security purposes.

3. The user chooses BUY from the menu.

4. The user is prompted to enter the channel number for the PPV channel of choice.

5. A Channel Lineup for the channel entered is retrieved from the Channel Lineup List in the Database Server.

6. The user chooses the PPV event of choice from the list of events.

7. The user is prompted with a list of Smart Cards associated with the user's ID.

8. The user chooses the Smart Card and clicks Send.

9. The m-PPV system notifies the IBS and CAMC services.

10.The m-PPV system sends a confirmation receipt to the user, which displays the PPV event, channel, date and time.

This completes the steps executed in a normal execution.

Once this process is completed, the m-PPV system will send a WML-encoded confirmation to the cellular gateway, which translates the signal and sends it to the cellular tower, which then sends it to the cellular customer. The customer receives a complete confirmation listing the serviceID of the PPV Event, the title of the PPV event, the channel, the date, and the time that the event will start.

In an alternate embodiment, the user receives an electronic mail message on the user's wireless communication device, a predetermined time prior to the start of the PPV event ordered by the user. This is accomplished by the Database Server, which contains listings of all PPV purchases according to PPV event, the time the PPV event starts, and the user ID information, which includes the e-mail address of each user's wireless communications device. In this fashion, the user receives a message as a reminder the event that was purchased is about to begin.

FIG. 3 shows a user's cellular phone 185 having a display screen 190, used in conjunction with the m-PPV system of the present invention. FIG. 3 shows the message display window 190 that represents the message on the information screen 95, as shown in FIG. 2. This welcome information 95 is presented to the user after the user has accessed the Server Database by entering the URL of the server. Welcome or introductory information 95 is displayed in the display screen 190 of cell phone 185.

This screen information 95 welcomes users and allows them to choose a language such as English, Spanish and Portuguese. After choosing a language, the user can either choose the country that they want information for, or enter login information. By logging in, the system can determine which information to display.

FIG. 4 shows the cell phone screen 190 with menu information, which provides selection options for the user. From here, users are able to navigate and check their account, the television schedule, PPV events, news and other services.

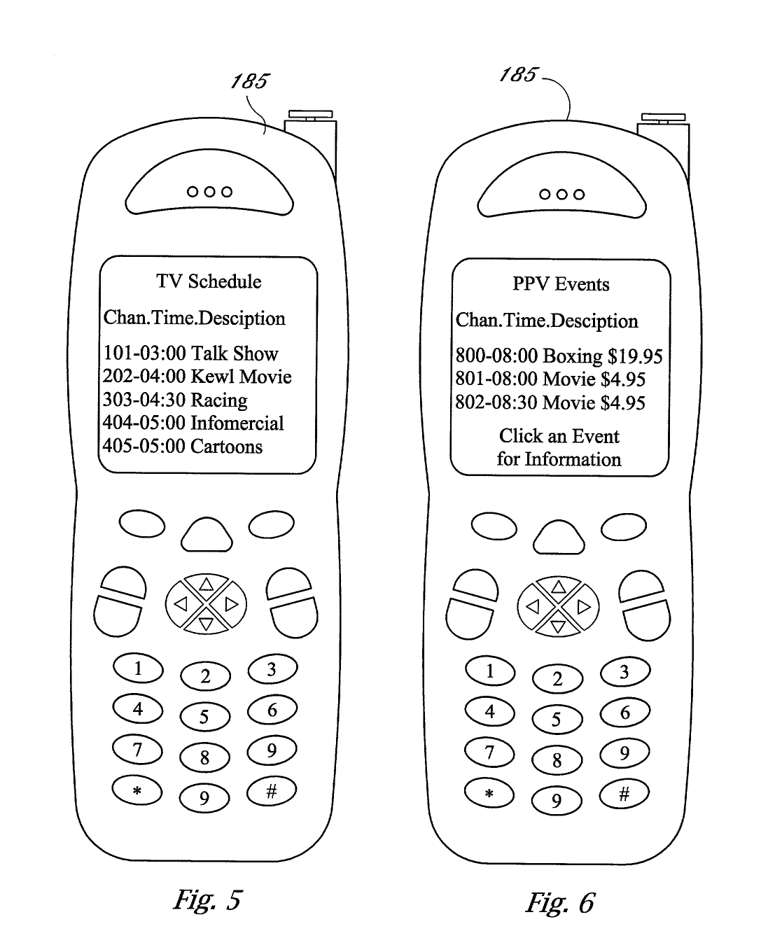

FIG. 5 shows the cell phone screen 190 displaying information that represents a Television Schedule/Guide Screen. On this screen is presented a list of the television guide by channel. Alternately, the user can input a channel, and the system displays the upcoming events for that specific channel. Users can have the flexibility of entering the channel number of choosing by name from the list of channels (DISNEY®, HBO®, etc.) and to input the time and date that they would like a listing for. For example, a user may request to see the schedule for the Disney® channel, 2 days from the actual date. As described above, the user can also have the ability to set a reminder feature where the phone will alert the user of an upcoming event or movie.

FIG. 6 depicts the user's cellular phone displaying a PPV Events Screen. The functionality in this view is similar to that of the TV schedule allowing the user to search by channel, time or date. The user may choose to purchase an event by logging in and purchasing the event for a specific date and time.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method of displaying television event guide information on a user's wireless data communication device to allow the user to purchase television programs and access user purchasing records, said system comprising the steps of:
(a) providing the user with a wireless data communication device;
(b) allowing said user to access a database stored on a server in a data communication network, said database containing television event schedules and user records of previous user purchases;
(c) displaying on the user's wireless communication device selection options including an option to purchase said television events and an option to view said user's television event purchasing records;
(d) responsive to the user's selection of said option to purchase said television programs, displaying on the user's wireless communication device a listing of available said television events;
(e) responsive to the user's selection of said option to view said user's television event purchasing records, displaying on the user's wireless communication device a listing of previous television event purchases by said user; and
(f) allowing the user to purchase said available television events.

2. The method of claim 1 wherein said user's wireless communication device is a cellular telephone.

3. The method of claim 2 wherein said cellular telephone is WAP enabled and said television event guide information is stored on a website that is WAP formatted.

4. The method of claim 1 wherein said user's wireless communication's device is a PDA.

5. The method of claim 1 wherein said television events are Pay-Per-View movies and promotional events.

6. The method of claim 1 wherein said step of allowing the user to access a database further comprises the step of receiving a user access code and matching said access code with a database of existing subscriber access codes.

7. The method of claim 1 wherein prior to step (c), receiving a user channel request, wherein said user requests television event schedule listings for a specific television channel.

8. The method of claim 1 wherein prior to step (e) allowing the user to identify a user account to be charged with said purchase if said user has multiple accounts.

9. The method of claim 1 further comprising the step of providing a call back message to the user's wireless data communication device prior to the start of the purchased event to remind the user that the purchased event is about to be aired.

10. A system for displaying television event guide information on a user's wireless data communication device to allow the user to purchase television programs and access user purchasing records, said system comprising:
(a) said wireless device;
(b) a database stored on a server in a data communication network, said database containing television event schedules and user records of previous user purchases;
(c) means for displaying on the user's wireless communication device selection options including an option to purchase said television events and an option to view said user's television event purchasing records;
(d) responsive to the user's selection of said option to purchase said television programs, means for displaying on the user's wireless communication device a listing of available said television events;
(e) responsive to the user's selection of said option to view said user's television event purchasing records, means for displaying on the user's wireless communication device a listing of previous television event purchases by said user; and
(f) means for allowing the user to purchase said available television events.

11. The system of claim 10 wherein said user's wireless communication device is a cellular telephone.

12. The system of claim 10 wherein said cellular telephone is WAP enabled and said television event guide information is stored on a website that is WAP formatted.

13. The system of claim 10 wherein said user's wireless communication's device is a PDA.

14. The system of claim 10 wherein said television events are Pay-Per-View movies and promotional events.

15. The system of claim 10 wherein said television event schedules and said user records of previous user purchases is only accessible via user identification means.

16. The system of claim 10 further comprising user identification means comprising a user access code wherein said user access code is compared to a database of existing subscriber access codes in order for the user to gain access to the system.

17. The system of claim 10 further comprising a user channel request, wherein said user requests television event schedule listings for a specific television channel.

18. The system of claim 10 further including identification means to allow said user to identify a user account to be charged with said purchase if said user has multiple accounts.

19. The system of claim 10 further comprising a call back message to the user's wireless data communication device prior to the start of the purchased event to remind the user that the purchased event is about to be aired.
